(19) United States
(12) Patent Application Publication
(10) Pub. No.: US 2016/0179846 A1
(43) Pub. Date: Jun. 23, 2016

(54) METHOD, SYSTEM, AND COMPUTER READABLE MEDIUM FOR GROUPING AND PROVIDING COLLECTED IMAGE CONTENT

(71) Applicant: KABUSHIKI KAISHA TOSHIBA, Tokyo (JP)

(72) Inventor: Yoshikata TOBITA, Nishitokyo Tokyo (JP)

(21) Appl. No.: 14/884,647

(22) Filed: Oct. 15, 2015

(30) Foreign Application Priority Data
Dec. 18, 2014 (JP) 2014-256413

(51) Int. Cl. G06F 17/30; G06K 9/62

(52) U.S. Cl. CPC G06F 17/30247; G06K 9/6218; G06K 9/6267; G06F 17/3028

(57) ABSTRACT

A system for grouping and providing collected image content is provided with an input module to which first images captured by a first user and second images captured by a second user are input. A processor groups the first images and the second images into at least a first group and a second group, using at least one of a similarity in times and dates of photography of the images, a similarity in locations of photography of the images, and a similarity in subjects or backgrounds included in the images. The processor selects at least one image from images belonging to the first group of the first images and at least one image from images belonging to the second group of the first images, and outputs the selected images as first representative images presented to the first user.

### CROSS-REFERENCE TO RELATED APPLICATIONS

This application is based upon and claims the benefit of priority from Japanese Patent Application No. 2014-256413, filed Dec. 18, 2014, the entire contents of which are incorporated herein by reference.

### FIELD

Embodiments described herein relate generally to a system, a method, and a computer readable media for grouping and providing collected image content.

### BACKGROUND

In recent years, as electronic apparatuses such as digital cameras and cellular phones with cameras become widespread, users have more opportunities to take photographs. In addition, there is a need to keep events in a group activity such as a trip with friends in albums, etc., and share memories. However, as digital cameras, etc., become widespread, the number of photographic images captured by the users is rapidly increasing, and it is becoming hard to share the captured photographic images and select photographic images to be printed after photography.

Against such a background, various retrieval methods have been proposed as a method of retrieving necessary data from content such as accumulated photographic images.

Conventional electronic devices group content (materials) such as photographic images on the basis of its creation time, and create a composite animation template using an attribute which attracts a lot of attention in each group. However, in the grouping of materials such as images by the conventional electronic devices, not photographic images captured by a number of imaging devices possessed by different users, but photographic images captured by an imaging device possessed by a single user in time series are basically grouped. Moreover, photographic images are grouped on the basis of creation times as a rule.

However, in a trip or marriage with friends, an exhibition, a museum, etc., different photographers have an opportunity to photograph an event or a phenomenon in a group activity at different times. Thus, the realization of a service in which materials of these photographic images are collected and accumulated to ascertain the tendency of photography, and representative photographs can be provided to participants from images captured by the participants has been desired. Moreover, in such a service, an electronic device which can perform grouping into photographic images suitable for individual participants to select and provide the photographic images to the individual participants on the basis of not only the material creation times of the photographic images has been desired. As an example, in a tour arranged by a travel agent, an electronic device which collects and accumulates photographic images captured by participants and provides photographic images suitable for the participants to select has been desired. In particular, it is becoming hard for even individual photographers to extract representative photographs from a huge number of images captured by themselves and prepare albums.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a block diagram schematically showing a representative image extraction system according to a first embodiment;

FIG. 2 shows a content data table in which attribute data of images stored in an image analysis result database shown in FIG. 1 is described in a table form;

FIG. 3 shows an object data table in which an association between the images stored in the image analysis result database shown in FIG. 1 and subjects is described in a table form;

FIG. 4 shows an object group data table in which subject data stored in the image analysis result database shown in FIG. 1 is described in a table form;

FIG. 5 is a flowchart showing a process of extracting representative images in a representative image extraction server shown in FIG. 1;

FIG. 6A is a distribution map conceptually showing image distribution in an image analysis space for explaining an image analysis in an image analyzer shown in FIG. 1;

FIG. 6B is a distribution map for explaining a concept of clustering an image distribution in the image analysis space shown in FIG. 6A and grouping images; and

FIG. 7 is a block diagram schematically showing a representative image extraction system according to a second embodiment.

### DETAILED DESCRIPTION

Representative image (best shot) extraction systems according to embodiments will be described hereinafter with reference to the accompanying drawings.

According to embodiments, there is provided a system comprising: a storage which stores first images captured by a first user and second images captured by a second user are input; and a processor coupled to the storage and which groups the first images and the second images into at least a first group and a second group, based at least in part on one of times and dates during which the images are captured, locations where the images are captured, and subjects and/or backgrounds included in the images, and which selects at least one image from the first images in the first group and at least one image from the first images in the second group, and outputs the selected images as first representative images presented to the first user.

### First Embodiment

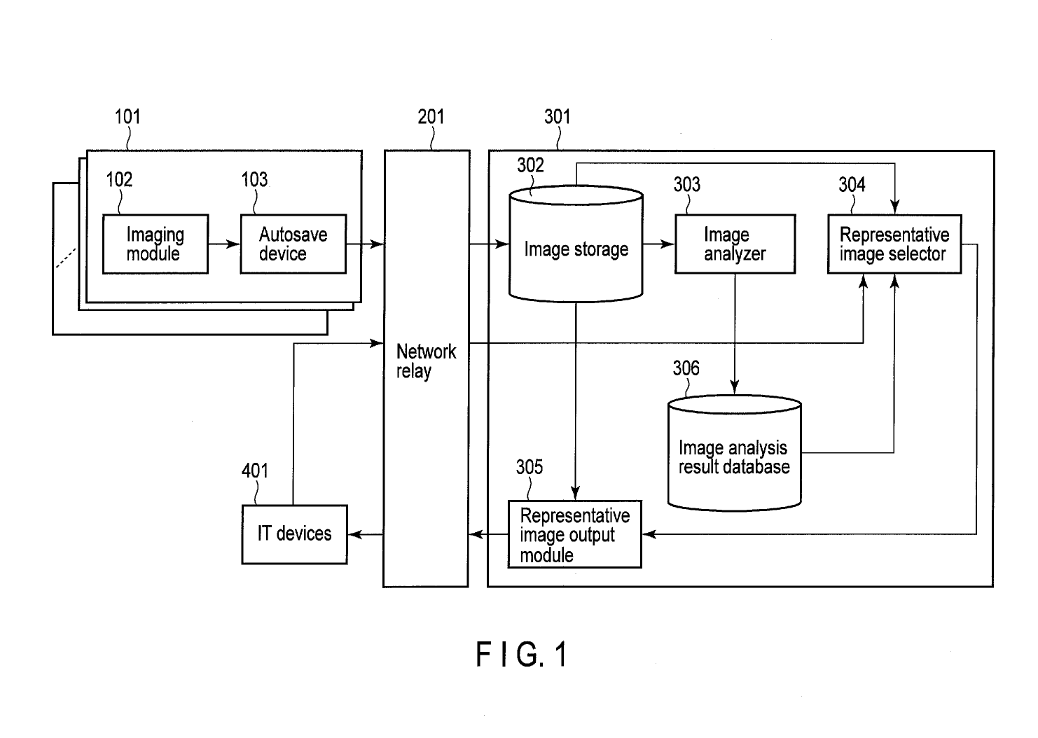

FIG. 1 is a block diagram schematically showing a representative image (best shot) extraction system according to a first embodiment. The representative image extraction system comprises imaging devices 101 such as digital cameras which photograph subjects, a representative image extraction server 301 which extracts a representative image (best shot) from a number of captured images (photographs), IT devices 401 such as smartphones possessed by users, and a network relay 201 which relays image data of captured images from the imaging devices 101 to the representative image extraction server 301 and transfers image data of the representative image from the representative image extraction server 301 to the IT devices 401. Here, the imaging devices 101 are possessed by different photographers, respectively, and photograph subjects with different timings (at different times and dates), and may photograph the same subject, for example, the same landscape or the same scene of a play, without the knowledge of the photographers. In addition, the IT devices 401 are set such that the users (viewers) who possess the IT devices 401 can receive provision of representative image data whether or not they possess the imaging devices 101. Here, the users (viewers) who possess the IT devices 401 basically correspond to the photographers of the imaging devices 101, and receive provision of representative photographs which are automatically selected from images captured by the photographers. If the users (viewers) who possess the IT devices 401 are the photographers of the imaging devices 101, the users (viewers) can access the system such that representative photographs are automatically selected from images captured by the photographers.

The imaging devices 101 each comprise an imaging module 102 which photographs a subject and creates an electronic image, and an autosave device 103 which comprises a memory card having a wireless LAN function such as FlashAir (registered trademark) and saves image data transferred from the imaging module 102. The autosave device 103 has a wireless LAN function, and thus can transmit saved image data to the representative image extraction server 301 via the network relay 201 such as a mobile router.

The representative image extraction server 301 comprises an image storage 302 in which transmitted image data is stored, an image analyzer 303 which analyzes images retrieved from the image storage 302, and an image analysis result database 306 in which image analysis result data of analysis by the image analyzer 303 is stored in a table form. The image analyzer 303 distinguishes persons, plants and animals, buildings, or landscapes which are subjects of the images, using an image recognition technique, and saves analysis result data based on the distinction, for example, an object group into which the subjects as objects are grouped, in a table form in the image analysis result database 306. In addition, the representative image extraction server 301 comprises a representative image (representative photograph) selector 304 which selects a representative image from images stored in the image storage 302, referring to the image analysis result data stored in the image analysis result database 306, and a representative image (representative photograph) output module 305 which outputs the selected representative image as image data via the network relay 201. Here, the representative image output module 305 extracts images from the image analysis result database 306 on the basis of a range of an extraction source image group of representative images specified in the IT devices 401, groups the extracted images into groups in the same number as the target number of representative images, and selects and outputs a representative image (best) from each group. Image data output from the representative image output module 305 is transmitted to the IT devices 401 via the network relay 201. Here, the users (viewers) who possess the IT devices 401 basically receive provision of representative photographs which are automatically selected from images captured by the photographers or other photographers closely related to (closely associated with) the photographers. The representative photographs are provided in consideration of the tendency of images captured by the other photographers on the basis of a result of an image analysis.

The IT devices 401 can specify a range of a source image group from which a representative image (representative photograph) is extracted from images (photographs) stored in the image storage 302, and specify the extraction target number of images extracted as representative images. The representative image output module 305 can transfer image data to the IT devices 401 via the network relay 201 in response to a request. In the image data, a display item for specifying a range of a source image group, for example, an item such as a photograph of Hawaii, a scene of a Hawaiian show, or a travel period, and an item for entering the extraction target number are displayed. Each of the IT devices 401 can transfer selective parameters indicated by these items to the representative image selector 304 via the network relay 201. That is, the users (viewers) who possess the IT devices 401 can specify a range of an extraction source image group of representative images, and further can specify the target number of representative images.

In the representative image extraction system shown in FIG. 1, when a subject is photographed by the imaging module 102, the imaging devices 101 transmit captured image data to the autosave device 103 inserted in the imaging devices 101, and save the image data. The autosave device 103 automatically transmits the image data to the network relay 201 over wired LAN or wireless LAN, for example, Wi-Fi. The network relay 201 transmits received images to the image storage 302 of the representative image extraction server 301 over the Internet. The image storage 302 transmits image data to the image analyzer 303. A number of images from the imaging devices 101 are stored in the image storage 302, and images captured by the photographers are analyzed by the image analyzer 303.

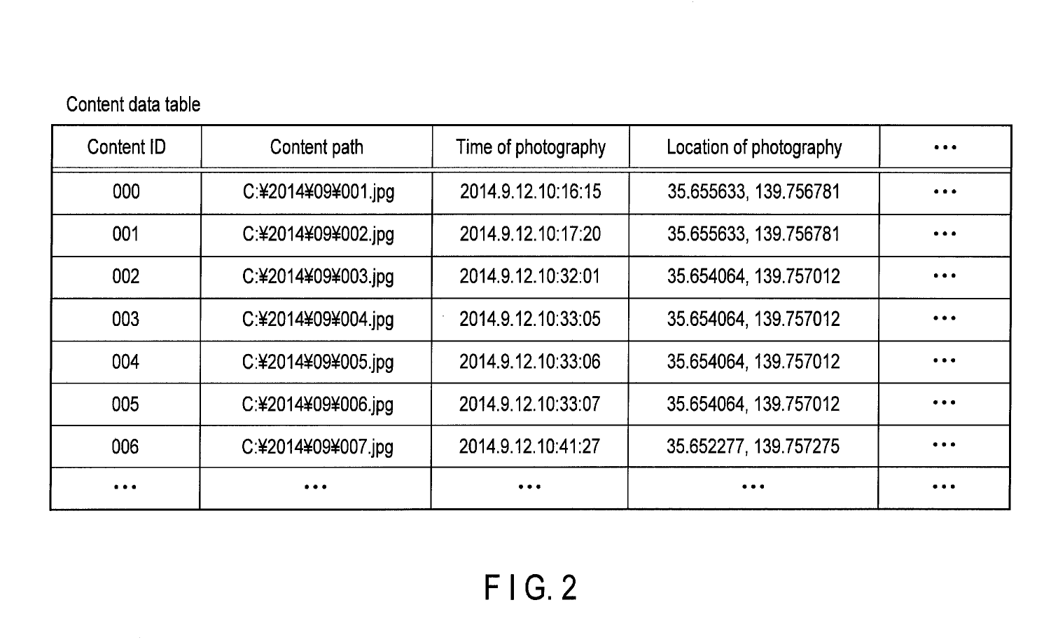

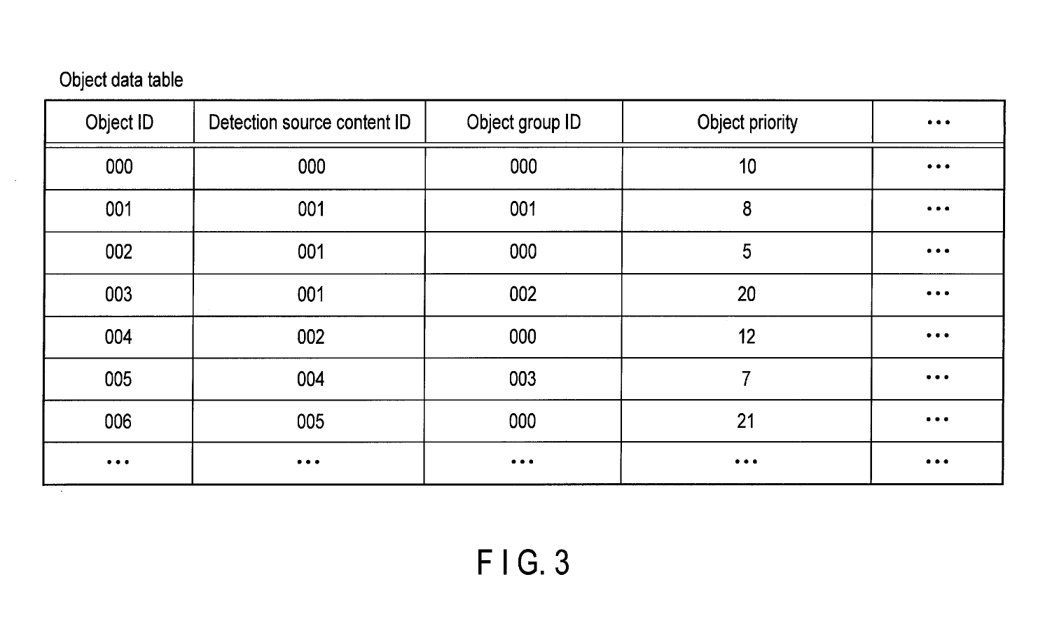

The image analyzer 303 performs image recognition of the received image data using an image recognition technique, distinguishes persons, plants and animals, buildings, or landscapes which are subjects of the images, and creates attribute data. The attribute data is, for example, created in the form of a content data table as shown in FIG. 2. As shown in FIG. 2, the content data table is provided with an item of content IDs which specify image data of each image, an item of content paths for reading each image data item in the image storage 302, and an item of locations of photography which specify a location of photography of each image data item with latitude and longitude. The content data table is provided with not only these items, but an item of photographer IDs for identifying photographers by device IDs of the imaging devices 101 associated with the photographers. The image analyzer 303 creates an object data table showing an association between the images of the received image data and the subjects in a table form as illustrated in FIG. 3, and stores the object data table in the image storage 302.

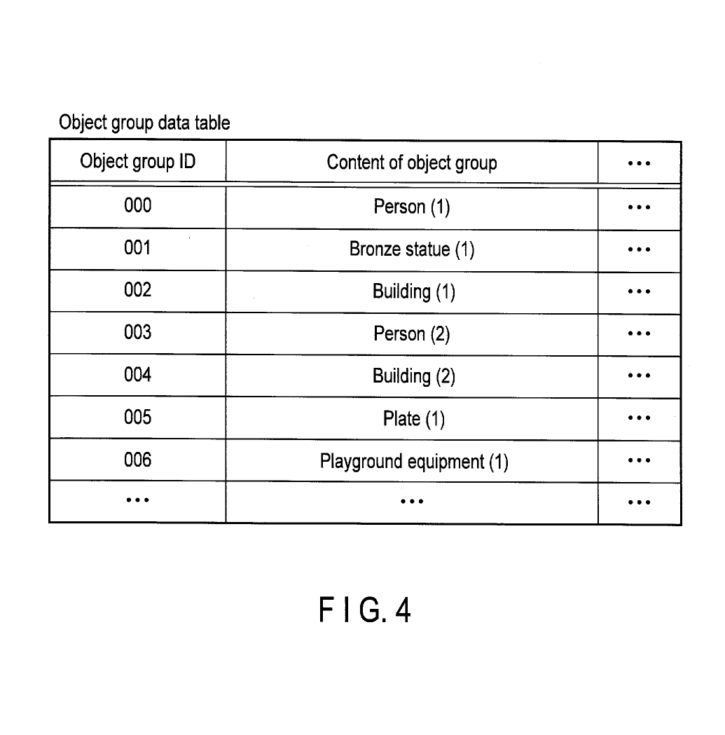

The object data table is provided with an item of object IDs which identify an object unique to each subject detected from the images. In the object data table, the content IDs shown in FIG. 2 which have a correlation with the object IDs are described as detection source content IDs. The content IDs of the images can be identified as detection sources by the detection source content IDs, and image data can be retrieved from the image storage 302 by the object IDs. Moreover, the object data table is provided with an item of object group IDs of the image data identified by the object IDs and an item of object priority indicating priority according to which the images identified by the object IDs are selected. Here, the object group IDs are IDs which identify a similarity between the images and the subjects (degree of coincidence with the subjects), and are IDs determined by grouping objects which seem to be the same subject. The object group IDs associate subject data with object groups as illustrated in FIG. 4. The image analyzer 303 analyzes images stored in the image storage 302, analyzes which of persons, landscapes, buildings, etc., subjects in the images belong to, and if the subjects are persons, classifies them as person (1), person (2), . . . , adding thereto the object group IDs. Similarly, if the subjects in the images are landscapes, the image analyzer 303 classifies them as landscape (1), landscape (2), . . . , adding thereto the object group IDs, and creates an object group data table shown in FIG. 4. Therefore, the object group IDs identify objects as groups which identify the subjects in the images, for example, a group of specific person (1) or specific person (2), a group of specific bronze statue (1), and a group of specific building (1) or specific building (2). Moreover, as shown in FIG. 3, in the object data table, the object group IDs are described to be associated with the object IDs. In addition, the object group data table is stored in the image storage 302. Here, if the object group IDs are the same (for example, object IDs [000], [002], [004] and [006] have the same object group ID [000]), it is meant that specific person (1) as a subject is photographed in images. Also, object priority is determined by the definition, the size, the expression, etc., of objects. More specifically, numerical values of the object priority are determined by adding points to images as objects in consideration of whether photographic images as objects are in focus so that they can be appreciated, whether they are captured without camerashake, whether the objects have definition with which they are bright enough to be visible even if they are captured against the sun, whether they are captured in a size which allows person (1) or building (1) as an object group to be identified in the images, or whether the expression of person (1) gives a dark impression. Moreover, in determining a similarity in subjects (degree of coincidence of the subjects), attention is focused on persons which are the subjects, the points of the object priority may be determined in consideration of not only a difference in the persons, but a difference in expressions of the persons, a difference in clothes of the persons, and a difference in backgrounds against the persons. Here, the difference in backgrounds includes a difference in plants and animals around the persons, a difference in buildings around the persons, a difference in landscapes around the persons, etc. In addition, in grouping an image group, the object priority may be determined with priority set for not only a similarity (degree of coincidence) in subjects, but times and dates of photography, and locations of photography.

After the object data table is stored in the image storage 302, an instruction to extract representative images is given to the representative image selector 304, based on an operation on a screen of the IT device 401 by the user who is a viewer. In this system, preferably, the viewer can access only images which the viewer captured as a photographer as a rule, and limitations are imposed such that images captured by a photographer closely associated with the viewer and images which the photographer allow the viewer to access are provided as representative images.

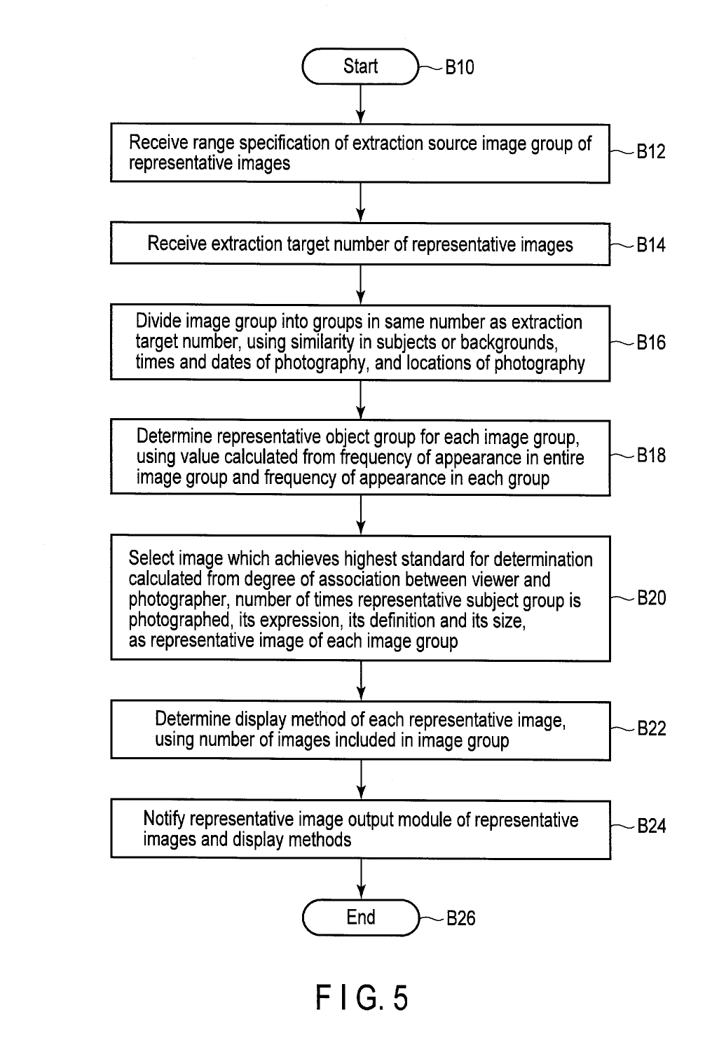

When an instruction to extract representative images is given, the representative image selector 304 searches the image storage 302, referring to the object data table, and selects representative images. More specifically, as shown in FIG. 5, the viewer inputs a range of a source image group for extraction and the target extraction number of representative images on the screen of the IT device 401, and the selection of representative images is started (block B10). Here, an instruction to extract representative images by the user (viewer) is transmitted to the representative image selector 304 together with a device ID of the imaging device 101 (designation of a photographer) and a device ID of the IT device 401 (designation of a viewer). Here, with the device ID of the imaging device 101 and the device ID of the IT device 401 regarded as a photographer ID and a viewer ID, respectively, the photographer can be identified by the device ID of the imaging device 101, and the user (viewer) can be identified by the device ID of the IT device 401. The representative image selector 304 receives a range specification of an extraction source image group of representative images from the IT device 401 (block B12). Thus, the representative image selector 304 identifies images in the range of the source image group, referring to the content data table shown in FIG. 2, the object data table shown in FIG. 3 and the object group data table shown in FIG. 4 according to the range of the source image group for extraction, and extracts data of an analysis result of the images from the image analysis result database 306. Here, it is highly probable that the viewer is photographed as a subject in the range of the source image group for extraction specified by the viewer, and a degree of association between the viewer and a photographer of an image can be determined from the degree of coincidence (similarity) in subjects photographed in the range of the source image group for extraction. Accordingly, the device ID of the imaging device 101 or the photographer ID may not necessarily be input. For example, if there are many images in which specific person (1) is photographed as a subject, a degree of coincidence is set at a value indicating a close association between the viewer and the photographer of the images, and is temporally saved in the representative image selector 304. A relationship between the viewer and the photographer is, for example, friends or a couple.

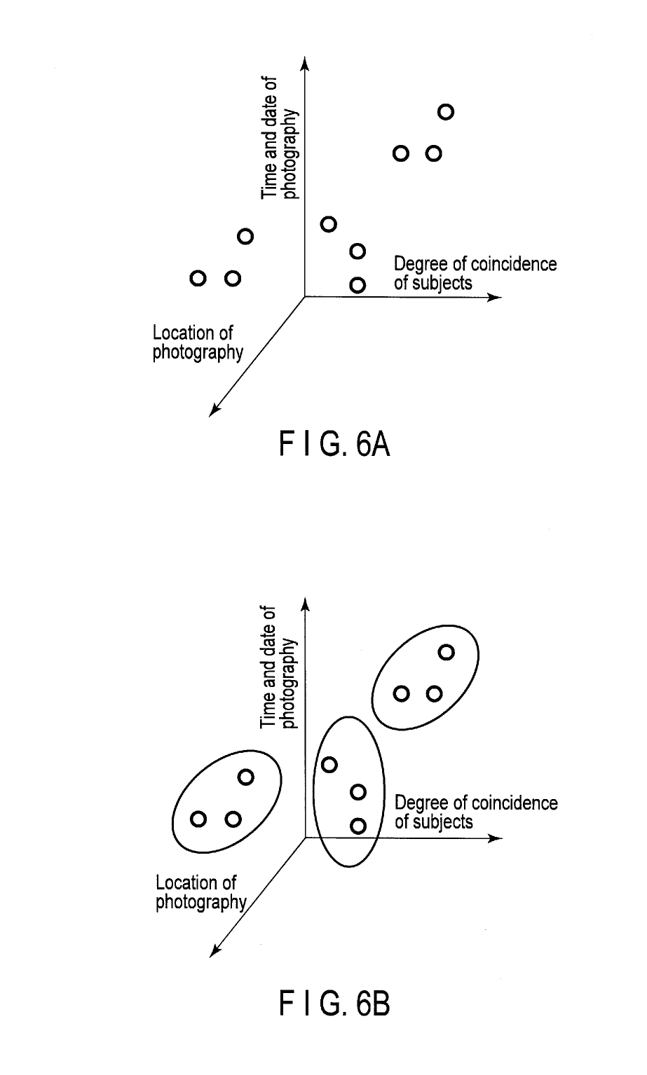

Analysis result data on extracted images is disposed in a conceptual three-dimensional space defined by times and dates of photography, locations of photography, and a degree of coincidence of subjects corresponding to a similarity in subjects or backgrounds as shown in FIG. 6A. The degree of coincidence of subjects corresponding to the similarity in subjects or backgrounds are converted into numbers by extracting and comparing images having the same or similar object group IDs. As shown in FIG. 6A, in the three-dimensional space, images are distributed in accordance with the times and dates of photography, the locations of photography, and the degree of coincidence of subjects corresponding to the similarity in subjects or backgrounds. The degree of coincidence of subjects is determined by how much the same subject (object group ID) is included.

Upon receiving the extraction target number of representative images from the IT device 401 (block B14), the representative image selector 304 clusters images disposed in the three-dimensional space into groups in the same number as the extraction target number, and classifies them into groups in the extraction target number as shown in FIG. 6B. That is, images distributed as shown in FIG. 6A are divided into groups in the same number as the extraction target number of representative images, using the similarities in subjects or backgrounds, the times and dates of photography and the locations of photography as shown in FIG. 6, (block B16). For example, if twelve representative images are selected for a calendar, twelve is selected as the extraction target number. Even if there is many good images such as are in focus, the images are grouped into twelve groups in advance and a representative image (best shot) in each group is extracted, because the extraction target number is determined for a calendar.

It should be noted that if twelve representative images (best shots) are extracted from one group, the selected best shots may include images of the same scene or subject, and are not suitable as images for a calendar.

The representative image selector 304 then determines a representative subject group for each image group, using a value calculated from the frequency of appearance in the entire image group and the frequency of appearance in each group (block B18). Here, a representative subject means such a representative subject among subjects as is photographed in many images. In addition, a set of representative subjects is referred to as a representative subject group.

The representative image selector 304 then selects an image which achieves a highest standard for determination calculated from a degree of association between a viewer and a photographer, the number of times a representative subject group is photographed, its expression, its definition and its size, as a representative image (best shot) of each image group, and transmits a selection result to the representative image output module 305 (block B20). If a photographer and a viewer are the same, a representative image (best shot) is basically selected from images captured by the photographer (specific photographer) in a group, and if a photographer and a viewer are different, a representative image (best shot) is selected from images captured by a photographer (specific photographer) closely associated with the viewer, for example, a friend. Here, in a certain group, even if images captured by the specific photographer (the same photographer as the viewer or the photographer closely associated with the viewer) are few, the images may be collected with a number of images provided by other photographers as a group. This group corresponds to a group which attracts a lot of attention, and a representative photograph is necessarily selected from the few images although the photographer may be unaware of them. In addition, in a certain group, if a number of images captured by the specific photographer (the same photographer as the viewer or the photographer closely associated with the viewer) are collected, an image which achieves a highest standard for determination calculated from the number of times a representative subject group is photographed, an expression, definition and a size is selected as a representative image (best shot). This group attracts a lot of attention of the specific photographer, and a representative photograph to be selected for the photographer is selected.

Moreover, the representative image selector 304 determines a display method of each representative photograph (best shot) using the number of images included in an image group (block B22). Then, the representative image selector 304 notifies the representative image output module 305 of representative images (best shots) and display methods, for example, thumbnail display or slide display (block B24). The representative image output module 305 transmits the received representative images and display methods to the network relay 201 over the Internet. The network relay 201 outputs the received images to the IT devices 401 over Wi-Fi. Therefore, the viewers who possess the IT devices 401 can display the received representative images by the best display method and determine a representative photograph to be distributed. Data of the representative photograph to be distributed is retrieved from the image storage 302 in response to a request for distribution, and can be received by the IT devices 401 via the representative photograph output module 305 and the network relay 201.

In the display methods of representative images (best shots), if the number of images belonging to one group (first group) is less than a predetermined threshold value and the number of images belonging to another group (second group) is greater than or equal to the predetermined threshold value, at least one image from the images belonging to the one group and at least one image from the images belonging to the other group (second group) are preferably displayed in different display forms. For example, in displaying the images belonging to the other group (second group), the images are preferably displayed to be visually distinguishable from the images belonging to the one group (first group). More specifically, the images belonging to the other group (second group) are displayed large to be more visible than the images belonging to the one group (first group). Therefore, representative photographs may be output with identification data on each image added thereto, in order to make each image visually distinguishable as a display method of representative photographs (best shots).

### Second Embodiment

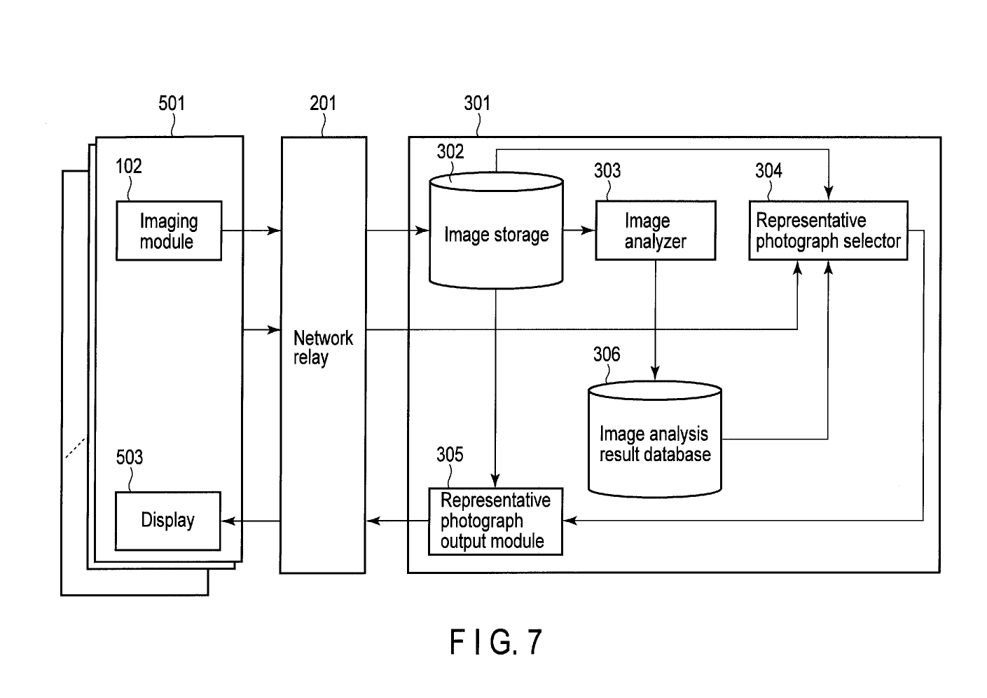

FIG. 7 schematically shows a representative image extraction system according to a second embodiment.

In FIG. 7, the same portions as those shown in FIG. 1 are given the same numbers, and an explanation thereof is omitted. The system shown in FIG. 7 differs from the system shown in FIG. 1 in that IT devices 501 are provided, and each of the IT devices 501 is intended for use in a smartphone, etc., comprising an imaging module 102 and a display 503.

In the system shown in FIG. 7, each of the IT devices 501 automatically transmits images captured by the imaging module 102 to the network relay 201 over Wi-Fi. The network relay 201 transmits the received images to an image storage 302 of a representative image extraction server 301 over the Internet. The representative image extraction server 301 is the same as shown in FIG. 1, and thus, an explanation thereof is omitted. When a representative image (best shot) and a display method are selected by the representative image extraction server 301, the representative photograph and the display method are transmitted from a representative image output image module 305 to the IT devices 501 via the network relay 201. In the IT devices 501, received representative photographs are displayed on the display 503 by the best designated display method, and representative photographs to be distributed are identified from the displayed representative photographs. Then, data of the representative photographs to be distributed is requested, and the data of the representative photographs is received.

In the above-described first and second embodiments, the image analyzer 303 and the representative photograph selector 304 can be constituted as firmware by an MPU not shown in the figures and a program which operates the MPU, and the program can execute the process of the flowchart shown in FIG. 5 and select representative photographs.

The above-described representative image extraction server 301 can be implemented as a server referred to as a so-called cloud, and can be applied to a system in which photographs are posted and saved on the cloud and the photographs posted on the cloud are shared. For example, the representative image extraction server 301 can be applied to a system in which a supporter of a group activity such as a travel agent distributes autosave devices such as FlashAir (registered trademark) to participants, the participants use them, and photographs taken by the participants, etc., are automatically saved on a cloud. In such a system, the photographs taken by the participants can be automatically saved by using the autosave devices set by the supporter of the group activity, and can be grouped according to a similarity in subjects, dates and times of photography, and locations of photography, and a representative photograph (best shot) of each group can be automatically extracted. It is therefore possible to satisfy the need to keep a result of a group activity such as a trip with friends in albums, etc., and share memories. In particular, it may be hard for even individual photographers to extract representative photographs from a huge number of images captured by themselves and prepare albums. However, since not only images which interest the photographers but images which interest other persons are grouped in a group, attention can also be paid to captured images of the photographers in the group, which helps the preparation of albums, etc.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A system comprising:
a storage which stores first images captured by a first user and second images captured by a second user; and
a processor coupled to the storage and which groups the first images and the second images into at least a first group and a second group, based at least in part on one of times and dates during which the images are captured, locations where the images are captured, and subjects and/or backgrounds included in the images, and which selects at least one image from the first images in the first group and at least one image from the first images in the second group, and outputs the selected images as first representative images presented to the first user.

2. The system of claim 1, wherein the first images and the first representative images are accessible by the first user.

3. The system of claim 1, wherein the processor outputs a degree of association between the first user and the second user, based at least in part on a degree of similarity between subjects included in the first images and subjects included in the second images.

4. The system of claim 1, wherein at least one image from the first images in the first group and at least one image from the first images in the second group are presented in visually different forms to the first user, when the number of the images in the first group is less than a first value, and the number of the images in the second group is greater than or equal to the first value.

5. The system of claim 1, wherein the processor selects at least one image from the first images in the first group and at least one image from the first images in the second group, based at least in part on one of frequency of appearance of specific subjects in the images, expressions of subjects in the images, definition of subjects in the images, and sizes of subjects in the images.

6. A method of providing representative images, the method comprising:
receiving first images captured by a first user and second images captured by a second user;
grouping the first images and the second images into at least a first group and a second group, based at least in part on one of times and dates during which the images are captured, locations where the images are captured, and subjects and/or backgrounds included in the images;
selecting at least one image from the first images in the first group and at least one image from the first images in the second group; and
outputting the selected images as first representative images presented to the first user.

7. The method of claim 6, wherein the first images and the first representative images are accessible by the first user.

8. The method of claim 6, further comprising outputting a degree of association between the first user and the second user, based at least in part on a degree of similarity between subjects included in the first images and the second images.

9. The method of claim 6, further comprising presenting at least one image from the first images in the first group and at least one image from the first images in the second group in visually different forms to the first user, when the number of the images in the first group is less than a first value, and the number of the images belonging to the second group is greater than or equal to the first value.

10. The method of claim 6, further comprising selecting at least one image from the first images in the first group and at least one image from the first images in the second group, based at least in part on one of frequency of appearance of specific subjects in the images, expressions of the subjects in the images, definition of the subjects in the images, and sizes of the subjects in the images.

11. A computer readable media embodying a program of instruction executable by a processor to perform a method of providing representative images, the method causing a computer to:
receive first images captured by a first user and second images captured by a second user;
group the first images and the second images into at least a first group and a second group, based at least in part on one of times and dates during which the images are captured, locations where images are captured, and subjects and/or backgrounds included in the images; and
select at least one image from the first images in the first group and at least one image from the first images in the second group, and output the selected images as first representative images presented to the first user.

12. The computer readable media of claim 11, wherein the first images and the first representative images are accessible by the first user.

13. The computer readable media of claim 11, wherein the method further causes the computer to output a degree of association between the first user and the second user, based at least in part on a degree of similarity between subjects included in the first images and the second images.

14. The computer readable media of claim 11, wherein the method further causes the computer to further present at least one image from the first images in the first group and at least one image from the first images in the second group in visually different form to the first user, when the number of the images in the first group is less than a first value, and the number of the images in the second group is greater than or equal to the first value.

15. The computer readable media of claim 11, wherein the method further causes the computer to select at least one image from the first images in the first group and at least one image from the first images in the second group, based at least in part on one of frequency of appearance of specific subjects in the images, expressions of the subjects in the images, definition of the subjects in the images, and sizes of the subjects in the images.
